(19) United States
(12) Patent Application Publication
(10) Pub. No.: US 2019/0257743 A1
(43) Pub. Date: Aug. 22, 2019

(54) HANDHELD DEVICE FOR HOLDING, AND LOADING/UNLOADING A FLUID FROM A SAMPLE CELL WHILE IN A VERTICLE ORIENTATION FOR USE IN POLARIMETERS AND METHOD OF LOADING/UNLOADING SAME

(71) Applicant: Rudolph Research Analytical Corporation, Hackettstown, NJ (US)

(72) Inventor: Jeff Wagner, Long Valley, NJ (US)

(21) Appl. No.: 16/280,441

(22) Filed: Feb. 20, 2019

Related U.S. Application Data
(60) Provisional application No. 62/633,341, filed on Feb. 21, 2018.

(51) Int. Cl. G01N 21/11; G01N 21/15; G01N 21/21

(52) U.S. Cl. CPC G01N 21/11; G01N 21/21; G01N 21/15

(57) ABSTRACT

A combination, handheld device for holding and loading/unloading a sample cell with a fluid sample, while the device is in a vertical orientation, is provided. The handheld device has a sample cell holder for selectively, removably holding the sample cell when the sample cell is in need of being filled with a fluid for testing in the polarimeter or is in need of being emptied of a fluid already tested in the polarimeter, and a sample cell fluid loader/unloader connected to and extending from, or unitarily formed with, the holder, the loader/unloader in fluid communication with the sample cell when the sample cell is held in the holder. Methods of loading and unloading a sample cell with a fluid sample using a combination, handheld device, are also provided.

### CROSS-REFERENCE TO RELATED APPLICATIONS

This application is a regular, U.S. utility patent application claiming the benefit of the filing date of, and priority to, U.S. Provisional Application No. 62/633,341, filed Feb. 21, 2018, the entirety of such application being incorporated herein by reference.

### TECHNICAL FIELD

This invention relates to polarimeters, and the sample cells used therein, and more particularly, to a handheld device for both holding the sample cell and loading/unloading the same with a fluid.

### BACKGROUND OF THE INVENTION

Analytical instruments such as polarimeters for measuring the optical rotation of samples are widely used for sample testing. Samples to be tested are usually loaded into a sample cell, and then the sample cell is inserted into the polarimeter for testing. After testing of the sample is completed, the sample must be unloaded from the sample cell so that the sample cell may be cleaned and then used again.

While there are many known devices and methods of loading/unloading sample cells with fluid samples, it is believed that all of these require horizontally holding of the sample cell and then bringing to the sample cell and its holder a fluid sample for injection into the horizontally oriented and separately held sample cell. It is believed there is no known device or method that allows for the sample cell to be carried to the fluid sample in a handheld device, where the handheld device combines both the holder of the sample cell and the mechanism for loading or unloading the fluid sample from the sample cell. It is further believed there is no known mechanism or method of loading/unloading a sample cell that is oriented in a vertical orientation.

Therefore, it would be desirable to provide an improved fluid sample loader and unloader and method that overcome the disadvantages discussed above.

### SUMMARY OF THE DISCLOSURE

According to one aspect of the present disclosure, a device for holding and loading/unloading a sample cell with a fluid, is provided. The combination device is a handheld device. The handheld device has a sample cell holder for selectively, removably holding the sample cell in a vertical orientation when the sample cell is in need of being filled with a fluid for testing in the polarimeter or is in need of being emptied of a fluid already tested in the polarimeter, and a sample cell fluid loader/unloader connected to and extending from the holder, the loader/unloader in fluid communication with the sample cell when the sample cell is held in the holder.

Further aspects of the device of the present disclosure include embodiments where (a) the holder and loader/unloader are unitary in their construction; (b) the holder is selectively detachable from the loader/unloader; (c) the fluid communication between the holder (and, therefore, the sample cell) and the loader/unloader is via an inlet/outlet port in the holder, connected between the holder inlet/outlet port and a nozzle of a suction device of the loader/unloader; (d) the holder has a second inlet/outlet port also in fluid communication with the sample cell and a tube extending from the holder; (e) the inlet/outlet ports of the holder are located substantially at opposite ends of the length of the holder; (f) the loader/unloader loads and unloads fluid from the sample cell via a suction device; (g) one such suction device being a syringe-type device; (h) the suction device having a receptacle as well as a plunger selectively slidable within the receptacle; (i) the loader/unloader is shaped so as to be able to be gripped in the hand of a user, with the user's thumb being in communication with the top of the plunger; (j) the loader/unloader having another inlet/outlet port extending therethrough and into the receptacle of the suction device, such another inlet/outlet port for allowing rinsing/cleaning liquid into and out of the receptacle, as well as for allowing air drying of the receptacle; (k) the another inlet/outlet port located along the suction device at an end substantially opposite the nozzle end; and (l) the suction device is selectively replaceable with other, or new, suction devices that are able to achieve the loading/unloading of the sample cell.

According to another aspect of the present disclosure, a method of loading a fluid sample into and unloading a fluid sample from a sample cell, is provided.

The method of loading the fluid sample into the sample cell comprising securing the sample cell within a holder of the combination, handheld holder and loader/unloader device, wherein the combination device holds the sample cell in a vertical orientation, inlet/outlet ports of the sample cell are in communication with first and second inlet/outlet ports of the holder of the device, inserting a first inlet/outlet tube extending from the first inlet/outlet port of the holder of the device into a fluid sample, and pulling the handle of a compressed suction device (such as, but not limited to, a syringe mechanism), in a direction so that the suction device fills with air pushed from the sample cell through a second inlet/outlet tube connected between the second inlet/outlet port of the holder and a nozzle end of the suction device as the sample cell fills with the fluid sample via the first inlet/outlet tube. This process being complete once the fluid sample starts entering the suction device through the nozzle. And, this process being accomplished with the sample cell in a vertical orientation, meaning the first inlet/outlet ports of the holder and sample cell are vertically below the second inlet/outlet ports of the holder and sample cell and that the sample cell therefore loads the fluid sample from the bottom thereof to the top thereof, namely, where the suction from the suction device pulls, while the incoming fluid pushes, the air upwards and out of the sample cell through the second inlet/outlet ports. Such a loading orientation is important since it helps to ensure the sample cell is without trapped air bubbles, since testing of the sample in the sample cell works best when there are no air bubbles in the fluid sample being tested.

The method of unloading the fluid sample from the sample cell comprising securing the sample cell within a holder of the combination, handheld holder and loader/unloader device, wherein first and second inlet/outlet ports of the sample cell are in fluid communication with first and second inlet/outlet ports of the holder of the device, compressing a plunger mechanism of a suction device filled with air and in fluid communication with the second inlet/outlet port of the sample cell until all of the fluid sample exits the sample cell via the first inlet/outlet tube extending from the holder of the device. A nozzle end of the suction device in fluid communication with the second inlet/outlet port of the holder via a second inlet/outlet tube. Here also, the vertical orientation of the sample cell in the combination device greatly assists in the unloading of the sample fluid from the sample cell.

### BRIEF DESCRIPTION OF THE DRAWINGS

For the purposes of illustrating various aspects of the disclosure, there are shown in the drawings aspects of the disclosure that are presently preferred. It being understood, however, that the disclosure is not meant to be limited, nor is it actually limited, to the precise arrangements, constructions or instrumentalities shown in the drawings.

FIG. 1 illustrates a combination handheld device for holding and loading/unloading a sample cell with a fluid according to one aspect of the present disclosure.

FIG. 2 illustrates a combination handheld device for holding and loading/unloading a sample cell with a fluid according to another aspect of the present disclosure.

FIG. 2a is a cross-sectional view along line a-a of FIG. 2.

FIG. 3 illustrates a combination handheld device for holding and loading/unloading a sample cell with a fluid according to yet another aspect of the present disclosure.

FIG. 4A illustrates a combination handheld device for holding and loading/unloading a sample cell with a fluid according to another aspect of the present disclosure.

FIG. 4B illustrates a combination handheld device for holding and loading/unloading a sample cell with a fluid according to another aspect of the present disclosure

### DETAILED DESCRIPTION OF THE INVENTION

In the following description, for purposes of explanation, specific numbers, materials and configurations are set forth in order to provide a thorough understanding of the disclosure. It will be apparent, however, to one having ordinary skill in the art that the disclosure may be practiced without these specific details. In some instances, well-known features may be omitted or simplified so as not to obscure the present disclosure. Furthermore, reference in the specification to phrases such as “one embodiment” or “an embodiment” means that a particular feature, structure or characteristic described in connection with the embodiment is included in at least one embodiment of the disclosure. The appearances of phrases such as “in one embodiment” or “in an embodiment” in various places in the specification do not necessarily all refer to the same embodiment.

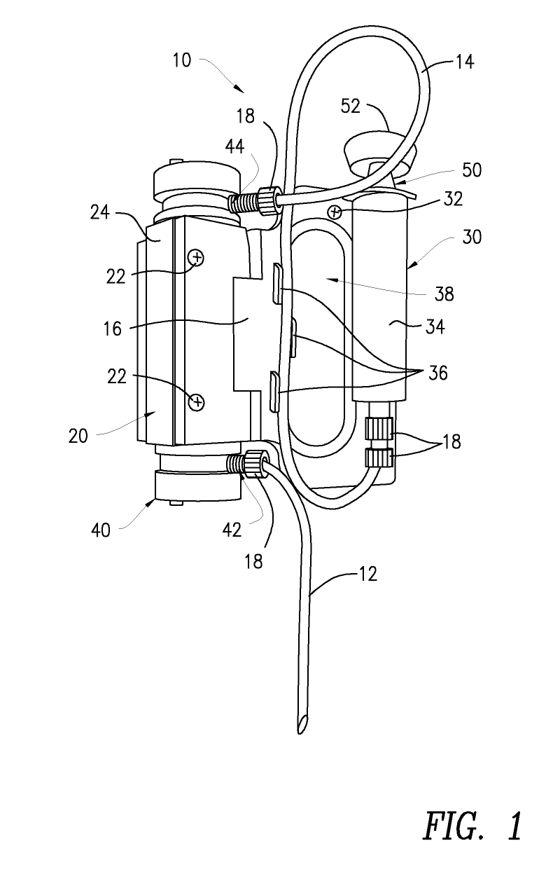

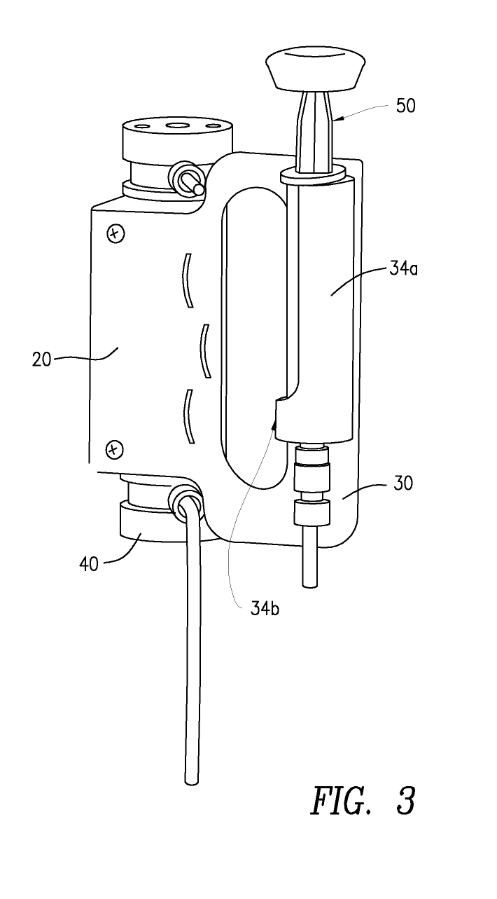

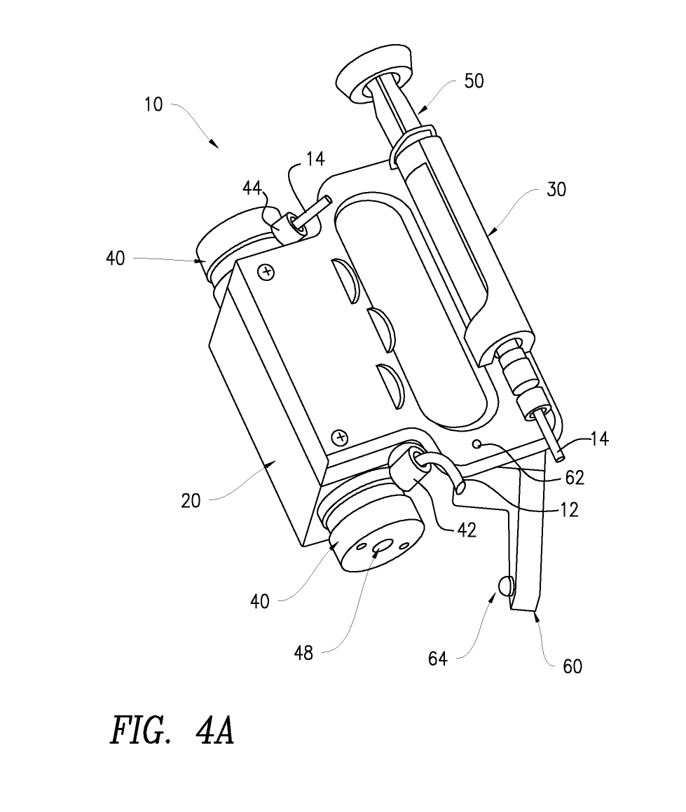

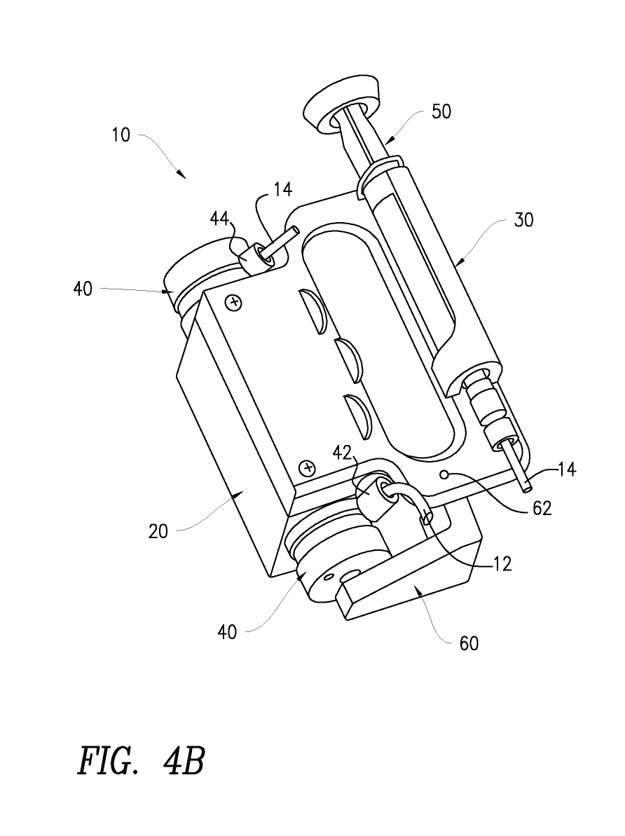

A combination handheld device for holding and loading/unloading a sample cell with a fluid is shown at 10 of FIG. 1. Handheld device 10 has a sample cell holder 20 and a sample cell fluid loader/unloader 30. While it is anticipated by the disclosure and shown in FIGS. 3, 4A and 4B that holder 20 and loader/unloader 30 may be unitarily formed so that they are not selectively attachable/detachable from each other, FIG. 1 shows a selectively attachable/detachable relationship between these two elements of device 10, at 16. Any known constructions for removably connecting these elements at 16 are anticipated by the disclosure.

Held within holder 20 is a sample cell 40. Sample cell 40 has inlet/outlet ports 42 and 44, through which a fluid sample (not shown) is loaded into and/or unloaded from sample cell 40 via use of loader/unloader 30. Holder 20 has a removable plate 24. When removable plate 24 is not secured to holder 20 by screws 22, sample cell 40 may be inserted into, or removed from, holder 20. The disclosure anticipates any and all other manners of construction for allowing selective insertion and removal of sample cell 40 from holder 20. Examples include, but are not limited to, pivoting door-like assemblies, snap in/out assemblies, slide in/out assemblies and even a Velcro® strap assembly. It is also anticipated that holder 20 have no selectively openable element for insertion/removal of sample cell 40, but that instead holder 20 is configured to snuggly hold a sample cell 40 within an opening therethrough and that the sample cell is slid into and out from this opening.

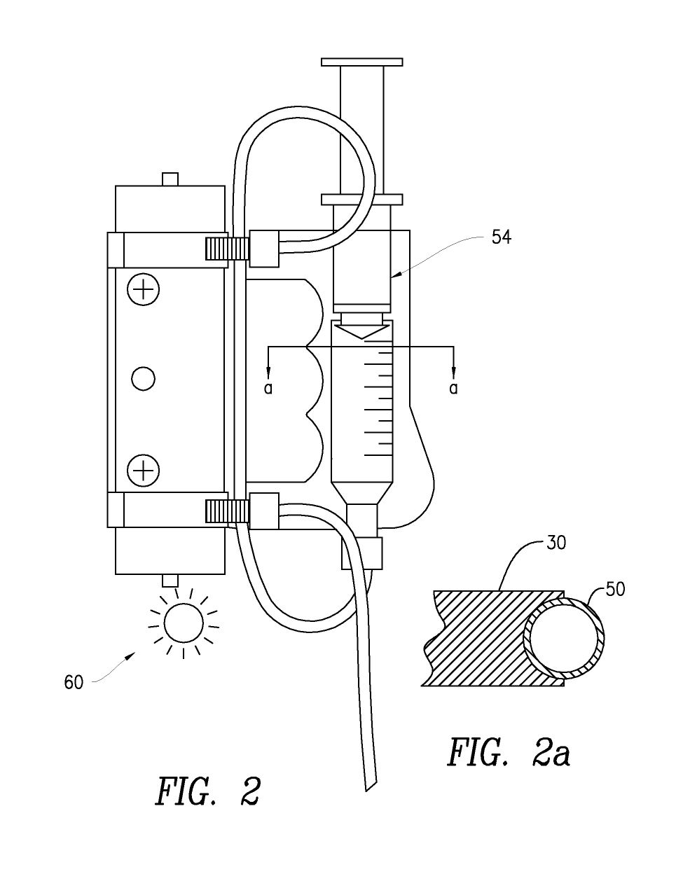

Loader/unloader 30 has selectively, removably secured thereon, a suction device 50. In a preferred embodiment, suction device 50 is a syringe-type device having a nozzle, a fluid holding receptacle and a plunger assembly slidable within the receptacle (see, for example, suction device 50 of FIG. 2). For the embodiment of FIG. 1, suction device 50 is selectively removable from loader/unloader 30 by restraining element 34, held to loader/unloader 30 by at least one screw 32. It is anticipated that restraining element 34 can be a hinged, door-type construction, wherein when screw 32 is removed element 34 is able to pivot open/closed around the hinge (not shown). It is also anticipated that a double screw 32 construction can be used and/or that even the single screw 32 would allow for secure attachment of suction device 50 to loader/unloader 30. Other constructions of this aspect of the disclosure will be discussed in association with the embodiments of FIGS. 2 and 3.

Suction device 50 and sample cell 40 are in fluid communication via inlet/outlet tube 14. In particular, tube 14 extends from the nozzle end of suction device 50 to inlet/outlet port 44 of sample cell 40. Standard industry known tube connection mechanisms 18 allow for the secure connection between tubes 12 and 14 and inlet/outlet ports 42 and 44, as well as, at the nozzle end of suction device 50.

Inlet/outlet tube 12 is connected to sample cell 40 at inlet/outlet port 42. In use, tube 12 is inserted into a container holding the fluid sample to be tested in the polarimeter. Then plunger 52 of suction device 50 is pulled outward from its receptacle in device 50. This pulling-out causes suction to take place within all of tubes 12 and 14 and sample cell 40, thereby causing some of the fluid sample to be pulled into sample cell 40 through tube 12 and inlet/outlet port 42. Once the user of device 10 sees the fluid sample start to exit sample cell 40 at inlet/outlet port 44, the user knows sample cell 40 is full.

The disclosure anticipates some of the length of tube 14 is removably held between tabs 36 of loader/unloader 30. The disclosure further anticipates the user holding device 10 in his/her hand, in a substantially vertical orientation with respect to the floor, wherein his/her palm wraps around restraining element 34 and his/her fingers extend through opening 38.

Turning to the embodiment of FIG. 2, while most of the construction of device 10 is similar to that shown and discussed above with respect to FIG. 1, some of the anticipated different embodiments are shown in FIG. 2. For example, in FIG. 2 it is seen that suction device 50 can be held in place on loader/unloader 30 by pressing suction device 50 into a crescent opening. Here, it is anticipated that a snug fit between suction device 50 and the crescent opening allows for both secure holding of suction device 50 and selective removal of suction device 50. This half-in, snug fit being best shown at FIG. 2a.

FIG. 2 also shows a liquid/air inlet/outlet port at 54. Port 54 is anticipated to be used in the cleaning process of device 10, including suction device 50, tubes 12 and 14 and sample cell 40. A flip in light 60 is also shown in FIG. 2 as a possible additional element to be added to device 10.

In addition to showing an extruded, unitary construction of device 10 in FIG. 3, FIG. 3 also shows an anticipated different construction for how suction device 50 is held by loader/unloader 30. In particular, restraining element 34a is shown to have only the bottom portion 34b thereof to fully encircle suction device 50 at only a lower, near-nozzle location of device 50.

FIGS. 4A and 4B again show most of the construction of device 10 as shown in the earlier figures, but also shows a preferred embodiment for flip light 60. In this embodiment, flip light 60 is seen to be pivotally and/or rotatingly held to loader/unloader 30 via a pin assembly 62. Any other means known in the art to pivotally and/or rotatingly attach one device to another device is anticipated herein for how flip light 60 is attached to device 10. Flip light 60 is in a position of non-use when light element 64 is pivoted/rotated away from sample cell 40 (FIG. 4A) and is in a position from it can be used when light element 64 is pivoted/rotated so that it touches sample cell 40 (FIG. 4B). When in the in-use position of FIG. 4B, light element 64 touches window 48 of sample cell 40, and through a similarly positioned window 48 on the other end of sample cell 40 (not shown), the user can look into sample cell 40 and see because of the light generated by element 64.

Due to the novel construction of device 10, sample cell 40 can be loaded or unloaded while in a vertical orientation. This has not been able to be accomplished with any past sample cell loader/unloader, due to the orientation of inlet/outlet ports 42 and 44. In particular, with inlet/outlet ports being located on opposite ends of cell 40, all past manners of loading a sample into the cell called for the cell to be in a substantially horizontal orientation in order to prevent the sample from spilling out of the end from which it was not being loaded. However, with this new construction for device 10 and the continuous fluid communication between all parts of device 10, the sample cell 40 is able to be loaded and carried around in a substantially vertical orientation, thereby greatly diminishing spillage of the sample fluid.

Although the disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the appended claims.

What is claimed is:

1. For a fluid holding sample cell for use in a polarimeter, a combination handheld device for holding and loading or unloading the sample cell with the fluid when the sample cell is in any orientation, including but not limited to, a substantially vertical orientation, the handheld device comprising:
a sample cell holder for selectively, removably holding the sample cell in any orientation, including, but not limited to, a substantially vertical orientation, when the sample cell is in need of being filled with a fluid for testing in the polarimeter or is in need of being emptied of a fluid already tested in the polarimeter; and
a sample cell fluid loader and unloader connected to and extending from the holder, the loader/unloader in fluid communication with the sample cell when the sample cell is held in the holder.

2. The combination handheld device of claim 1, wherein the holder and loader/unloader are of a unitary construction.

3. The combination handheld device of claim 1, wherein the holder and loader/unloader are selectively separable.

4. The combination handheld device of claim 1, further comprising a suction device selectively, removably attached to the loader/unloader, wherein the suction device is in fluid communication with the sample cell.

5. The combination handheld device of claim 4, wherein the suction device is a syringe comprising an outer barrel within which a plunger is selectively slidable.

6. The combination handheld device of claim 5, the syringe further comprising an additional opening through the barrel for introducing cleaning fluids or compressed gases.

7. A method of loading a fluid sample into a sample cell using a combination handheld holder and loader/unloader device, comprising the steps of:
securing the sample cell within a holder of the combination handheld device;
attaching a first end of a first inlet/outlet tube to a first inlet/outlet port of the sample cell;
attaching a first end of a second inlet/outlet tube to a second inlet/outlet port of the sample cell, wherein a second end of the second tube is in fluid communication with a nozzle end of a suction device attached to the combination handheld device;
inserting a second end of the first tube into a fluid sample so that the sample cell is in a substantially vertical orientation;
manipulating the suction device to create suction into the nozzle end of the suction device, through the second tube, through the sample cell, and through the first tube so that the fluid sample is pulled into the sample cell through the first tube.

8. The method of claim 7, wherein the sample cell is selectively, removably secured to the combination handheld device in the securing step.

9. The method of claim 7, wherein the suction device is selectively, removably attached to the combination handheld device.

10. The method of claim 7, wherein the suction device is a syringe-type device.

11. The method of unloading a fluid sample from a sample cell using a combination handheld holder and loader/unloader device, comprising the steps of:
securing the sample cell within a holder of the combination handheld device;
attaching a first end of a first inlet/outlet tube to a first inlet/outlet port of the sample cell;
attaching a first end of a second inlet/outlet tube to a second inlet/outlet port of the sample cell, wherein a second end of the second tube is in fluid communication with a nozzle end of a suction device attached to the combination handheld device;
positioning the second end of the first tube over a receptacle;
manipulating the suction device to force air from the suction device into the sample cell through the second tube, thereby pushing the fluid sample from the sample cell into the receptacle through the first tube.

12. The method of claim 11, wherein the sample cell is selectively, removably secured to the combination handheld device in the securing step.

13. The method of claim 11, wherein the suction device is selectively, removably attached to the combination handheld device.

14. The method of claim 11, wherein the suction device is a syringe-type device.

15. For a fluid holding sample cell for use in a polarimeter, a combination handheld device for holding and loading or unloading the sample cell when the sample cell is in any orientation, including but not limited to, a substantially vertical orientation, with the fluid, the handheld device comprising:
a fluid sample holding cell adapted to accept the optical beam of a polarimeter;
means for suctioning a fluid from a fluid sample source into the fluid sample holding cell; and
a tube through which to conduct the fluid sample from the fluid sample source into the sample cell.

16. The combination handheld device of claim 15, wherein the holder and loader/unloader are of a unitary construction.

17. The combination handheld device of claim 15, wherein the holder and loader/unloader are selectively separable.

18. The combination handheld device of claim 15, wherein the suction means is a selectively, removably attached syringe in fluid communication with the sample cell.

19. The combination handheld device of claim 15, wherein the suction means is reversible to provide pressure to unload the fluid sample cell.

20. The combination handheld device of claim 15, the suction means further comprising a port for introducing cleaning solvents or compressed air to clean the sample cell.

21. The combination handheld device of claim 15, the suction means further comprising a transparent area for viewing the interior of the suction means and seeing the fluid sample located therein.
